(19) United States
(12) Patent Application Publication
(10) Pub. No.: US 2004/0095327 A1
(43) Pub. Date: May 20, 2004

(54) Alphanumeric data input system and method

(76) Inventor: Fook Loong Lo, Hong Kong (HK)

Correspondence Address: Thomas E. Sisson, JACKSON WALKER L.L.P., Suite 2100, 112 E. Pecan Street, San Antonio, TX, 78205, US

(21) Appl. No.: 10/294,256

(22) Filed: Nov. 14, 2002

(51) Int. Cl. G09G 5/00

(52) U.S. Cl. 345/169

(57) ABSTRACT

An alphanumeric data input system, and related method, comprising a 3×4 alphanumeric keypad of keys, a display, and a program controlling the operation of these components. The keys represent digits from “0” to “9” and “*” and “#” signs respectively and the keys for digits from “2” to “9” also represent the letters of alphabet sequentially in respective groups of three to four letters. At least one of the keys upon pressing will cause the display to display the letters of the associated group in both lowercase and uppercase and the associated number together in the form of a grid of locations corresponding in position to the keys of the keypad. Subsequent pressing of one of the keys corresponding to the location at which a desired character is displayed will result in input of that character. Pressing of the keys representing the initial string of a word will enable matching through the database for a word sharing the same initial string and then displaying of the word in its root form on the display. Subsequent pressing of one or more of the keys representing a respective suffix available from the database will result in addition of the suffix to the root word and thus input of the complete word.

The present invention relates to a system and a method for inputting (and retrieving) alphanumeric data.

### BACKGROUND OF THE INVENTION

A standard 3×4 alphanumeric keypad, for example as used on mobile phones, has twelve keys, namely ten keys representing the digits “0” to “9” respectively, another key representing the asterisk sign “*” and a further key representing the pound sign “#” (FIG. 1). Due to the limited number of keys, it is not possible to map each letter of the alphabet to one particular key. Thus, the digit keys “2” to “9” are also used to denote the letters from “a” to “z” divided sequentially into eight groups respectively, each of three to four letters, which can be retrieved through multiple pressings in the alphanumeric mode.

In order to type a specific letter, the relevant key will have to be pressed more than once before the desired letter is obtained, with the last depression denoting the corresponding digit. Such a standard multi-tap method requires the user to press a key associated with three to four letters until the intended letter is displayed. Thus, if “c” is to be typed, the key “2abc” must be pressed three times quickly. This input method, needless to say, is extremely tedious. It becomes even worse if symbols and punctuation marks in particular, or capital letters in some cases, need to be typed as well.

Most mobile phones nowadays use text-predictive methods to shorten the process of text entry. For the T-9 and eZiText systems, for example, a dictionary of commonly used words is used to determine the most likely letter that the user wants based on the keys that have been pressed. At its highest efficiency, only one key press may be needed per letter typed. Other systems, such as LetterWise, uses a list of linguistic rules, instead of a dictionary, to determine which is the most likely letter wanted based on the letters already typed.

These text-predictive methods, whilst they are efficient for entering commonly used words, are of little use for inputting names, URLs (uniform resource locators), e-mail addresses, passwords and other uncommon alphanumeric strings. Moreover, the typing of punctuation marks, such as comma, period and question and exclamation marks, as well as signs, such as dollar sign, ampersand and asterisk, invariably involves the calling up and scrolling through of a long list of such symbols.

A further disadvantage lies in the need to type the complete word, but long words, such as “illumination” and “approximately”, can actually be determined from the first few letters initially typed.

The invention seeks to mitigate or at least alleviate such problems by providing an improved alphanumeric data input apparatus and method.

### SUMMARY OF THE INVENTION

According to a first aspect of the invention, there is provided an alphanumeric data input system comprising a 3×4 alphanumeric keypad of keys, a display, and a program controlling the operation of these components. The keys represent digits from “0” to “9” and “*” and “#” signs respectively and the keys for digits from “2” to “9” also represent the letters of alphabet sequentially in respective groups of three to four letters. At least one of the keys upon pressing will cause the display to display the letters of the associated group in both lowercase and uppercase and the associated number together in the form of a grid of locations corresponding in position to the keys of the keypad. Subsequent pressing of one of the keys corresponding to the location at which a desired character is displayed will result in input of that character. This allows any sequence of characters to be inputted.

Preferably, a predetermined location of the grid is arranged to display the number associated with the key first pressed.

More preferably, the predetermined location of the grid is the last location of the third row.

In a preferred embodiment, the keys for “0” and “1” also represent punctuation marks and symbols. Either one of these keys upon pressing will cause the display to display a set of predetermined punctuation marks or symbols in the form of a grid of locations corresponding in position to the keys of the keypad. Subsequent pressing of one of the keys corresponding to the location at which a desired punctuation mark or symbol is displayed will result in input of that mark or symbol.

It is further preferred that one of the displayed locations represents additional punctuation marks or symbols. Pressing of the key corresponding to that location will cause the display to display a set of the additional punctuation marks or symbols in the form of a grid of locations corresponding in position to the keys of the keypad for subsequent input of a desired punctuation mark or symbol in the aforesaid manner.

The invention also provides an alphanumeric data input method comprising the steps of providing a 3×4 alphanumeric keypad of keys and a display, and running a program to control the operation of these components. The keys represent digits from “0” to “9” and “*” and “#” signs respectively and the keys for digits from “2” to “9” also represent the letters of alphabet sequentially in respective groups of three to four letters. The method includes pressing at least one of the keys to cause the display to display the letters of the associated group in both lowercase and uppercase and the associated number together in the form of a grid of locations corresponding in position to the keys of the keypad, and subsequently pressing one of the keys corresponding to the location at which a desired character is displayed to input that character. This allows any sequence of characters to be inputted.

Preferably, the method includes displaying the number associated with the key first pressed at a predetermined location of the grid.

More preferably, the predetermined location of the grid is the last location of the third row.

In a preferred embodiment, the keys for “0” and “1” also represent punctuation marks and symbols. The method includes pressing the key for “0” or “1” to cause the display to display a set of predetermined punctuation marks or symbols in the form of a grid of locations corresponding in position to the keys of the keypad, and subsequently pressing one of the keys corresponding to the location at which a desired punctuation mark or symbol is displayed to input that mark or symbol.

It is further preferred that one of the displayed locations represents additional punctuation marks or symbols. The method further includes pressing the key corresponding to that location to cause the display to display a set of the additional punctuation marks or symbols in the form of a grid of locations corresponding in position to the keys of the keypad for subsequent input of a desired punctuation mark or symbol in the aforesaid manner.

According to a second aspect of the invention, there is provided an alphanumeric data input system comprising a 3×4 alphanumeric keypad of keys, a display, a memory storing a database of words and suffixes, and a program controlling the operation of these components. The keys represent digits from “0” to “9” and “*” and “#” signs respectively and the keys for digits from “2” to “9” also represent the letters of alphabet sequentially in respective groups of three to four letters. Pressing of the keys representing the initial string of a word will enable matching through the database for a word sharing the same initial string and then displaying of the word in its root form on the display. Subsequent pressing of one or more of the keys representing a respective suffix available from the database will result in addition of the suffix to the root word and thus input of the complete word.

Preferably, a first predetermined key is arranged upon pressing to terminate the input of the initial string, and a second predetermined key is arranged upon pressing to terminate the input of the suffix.

More preferably, the first and second predetermined keys are the keys for “1” and “0” respectively.

In a preferred embodiment, each suffix is represented by one or more letters comprised thereby, and is arranged to be inputted by pressing the associated key or keys.

Preferably, the suffixes that are represented by one letter are represented by their only or initial letter.

It is preferred that each root word is stored in the database in three fields, with the first field for a number string corresponding to its letters for matching, the second field for the word itself, and the last field for an alphabet string representing all possible suffixes for the word.

It is further preferred that the suffixes represented by the alphabet string are each represented by a single distinctive letter.

The invention also provides an alphanumeric data input method comprising the steps of providing a 3×4 alphanumeric keypad of keys, a display and a memory storing a database of words and suffixes, and running a program to control the operation of these components. The keys represent digits from “0” to “9” and “*” and “#” signs respectively and the keys for digits from “2” to “9” also represent the letters of alphabet sequentially in respective groups of three to four letters. The method includes pressing the keys representing the initial string of a word for matching through the database for a word sharing the same initial string and then displaying the word in its root form on the display, and subsequently pressing one or more of the keys representing a respective suffix available from the database for addition of the suffix to the root word and thus input of the complete word.

Preferably, the method includes pressing a first predetermined key to terminate the input of the initial string, and pressing a second predetermined key to terminate the input of the suffix.

More preferably, the first and second predetermined keys are the keys for “1” and “0” respectively. In a preferred embodiment, each suffix is represented by one or more letters comprised thereby. The method includes pressing the associated key or keys to input the suffix.

Preferably, the suffixes that are represented by one letter are represented by their only or initial letter.

It is preferred that the method includes storing each root word in the database in three fields, with the first field for a number string corresponding to its letters for matching, the second field for the word itself, and the last field for an alphabet string representing all possible suffixes for the word.

It is further preferred that the suffixes represented by the alphabet string are each represented by a single distinctive letter.

### BRIEF DESCRIPTION OF DRAWINGS

The invention will now be more particularly described, by way of example only, with reference to the accompanying drawings, in which:

FIG. 1 is a schematic view of an embodiment of an alphanumeric data input system based on an alphanumeric data input method in accordance with the invention, said system including a display and an alphanumeric keypad;

FIGS. 2 and 3 are schematic views of the display of FIG. 1, displaying different grids of alphanumeric characters for selection;

FIGS. 4 and 5 are two further schematic views of the display of FIG. 1, displaying different grids of punctuation marks and symbols respectively for selection;

FIG. 6 is another schematic view of the display of FIG. 1, displaying different words for selection; and

FIG. 7 is a flow chart illustrating part of the operation of the input method.

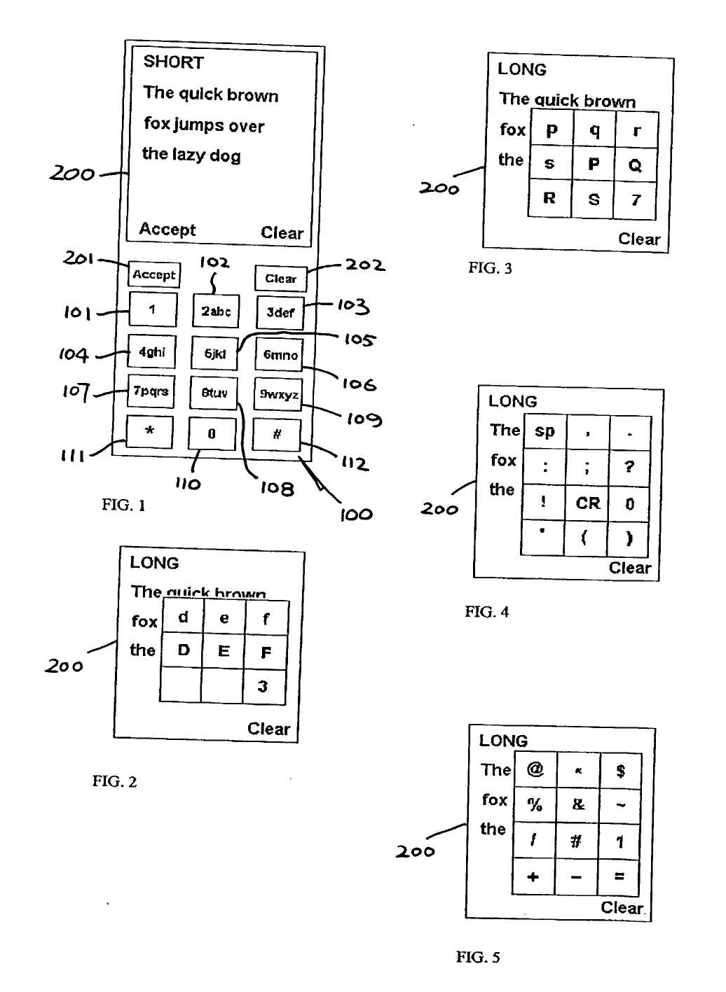

### DETAILED DESCRIPTION OF PREFERRED EMBODIMENT

Referring to the drawings, there is shown an alphanumeric data input system operating based on an alphanumeric data input method, embodying the invention, suitable for use in a mobile phone or any other keypad device. The input system comprises an alphanumeric keypad 100 of the phone, a display 200 on the phone above the keypad 100, and two additional, software-dependent keys 201 and 202 of the phone. These two keys 201 and 202 are usually placed right below the display 200, and their functions are variable according to the program in use. All these components are controlled by a program based on the input method, which includes a dictionary database of words and is stored in an internal memory of the phone.

The keypad 100, like any other standard alphanumeric keypads, has twelve keys 101 to 112, namely ten keys 101 to 110 representing the digits from “1” to “9” and “0” respectively, another key 111 representing the asterisk sign “*” and a further key 112 representing the pound sign “#”. As is generally known, the digit keys 102 to 109 also denote the letters of alphabet sequentially in respective groups of three to four letters as shown, depending upon the condition in which the keypad 100 operates.

The two software keys 201 and 202, which designate “Accept” and “Clear”, are positioned near the physical keys 101 and 103 respectively, similar to the usual layout on a standard mobile phone.

The input system/method has three input modes, namely SHORT, LONG and NUMBER modes, with the SHORT mode being the default mode upon initial invoking of the input method. To switch to the LONG mode, the “*” key 111 should be pressed, which upon repeated pressings will toggle between the SHORT and LONG modes. Pressing of the “#” key 112 will bring up the NUMBER mode, and repeated pressings thereof will cause toggling between the SHORT and NUMBER modes. In all the modes, pressing the “Clear” key 202 is equivalent to pressing the backspace key on a standard keyboard, thereby deleting the character last entered or before the current cursor position. Pressing of the “Accept” key 201 will cause the input system/method to send the entire inputted text on the display 200 to the application that is using the input method.

In the NUMBER mode, pressing of the “1” to “0” keys 101 to 110 will enter the corresponding numbers onto the display 200, which is useful for entering numerical data such as phone numbers and values.

The LONG mode is for inputting alphanumeric texts by entering the letters and occasional punctuation marks and symbols sequentially one-by-one, each using two keys. Any strings of alphanumeric characters can be entered.

In the LONG mode, the pressing of any one of the “2” to “9” keys 102 to 109 will bring up a 3×3 grid of nine boxes on the display 200, which contains the associated letters arranged in the lowercase and then uppercase form and followed by the same number. For example, the grid of FIG. 2 will be displayed when the “3” key 103 is pressed, or that of FIG. 3 will show up upon pressing of the “7” key 107.

The grid of boxes corresponds in position to the upper three rows of keys 101 to 109 on the keypad 100, and the letters and number displayed therein are arranged in the same order, i.e. from left to right in each row and starting from the top row downwards. Based on the grid, the desired letter (or number) may be entered by pressing the key (a second key) of the keypad 100 at the corresponding position. For example, pressing of the “4” key 104 on the keypad 100 will enter the letter “D” from the grid of FIG. 2 or the letter “s” from the grid of FIG. 3.

In the grid of FIG. 3, as there are eight lowercase and uppercase letters ahead, the number “7” falls right in the last, bottom right box (the last box of the third row or the “9” position). In the grid of FIG. 2, although there are less, only six letters ahead, the number “3” remains arranged in the same last box of the third row. This is done for simplicity, in that the “9” key of the keypad 100 can always be used to enter a number in this mode, thereby facilitating typing.

For languages other than English, which may possess more letters or include letters with diacritics, a 3×4 grid of twelve boxes may be displayed upon pressing of the first key, as opposed to the aforesaid 3×3 grid. This grid of boxes corresponds in position to all four rows of keys 101 to 109, 111, 110 and 112 of the keypad 100, and the letters and number displayed therein are arranged in the same order. Ten of the letters together with the number denoted by the key first pressed may be displayed at one time, with the number at the same box referred to above, i.e. the last box of the third row. The remaining box, preferably the bottom right box, i.e. the last box of the fourth row, may be used for bringing up twelve more choices in the next screen.

If a wrong first key has been pressed, the grid of boxes can be cleared from the display 200 using the “Clear” key 202. The “Clear” key 202 is also useful as backspace to delete a wrong letter/number entered.

Neither the “0” key nor the “1” key has been assigned with any letters. Instead, pressing the “0” key will bring up a 3×4 grid of twelve boxes containing various punctuation marks and the number itself as shown in FIG. 4, and the “1” key is programmed to display a 3×4 grid of various symbols and the number itself as shown in FIG. 5. In FIG. 4, “sp” stands for space, and “CR” stands for carriage return or line feed. Each of these grids of boxes corresponds in position to all four rows of keys 101 to 109, 111, 110 and 112 of the keypad 100, with the denoted number at the same box referred to above, i.e. the last box of the third row.

Based on either grid, any one of the boxed marks or symbols may be chosen by pressing the corresponding key (a second key) of the keypad 100. For example, pressing of the “7” key 107 will enter the mark “!” from the grid of FIG. 4, and pressing of the “5” key 105 will enter the symbol “&” from the grid of FIG. 5. If more than twelve symbols or punctuation marks are included, such as “<” and “>”, one of the boxes in the grid can be programmed to call up another grid for displaying the additional marks or symbols for more choices.

The SHORT mode, which is used for entering commonly used words, is relatively more complicated than the other two modes. For the input of a complete word, the number keys 102 to 109 representing the letter groups that correspond to the letters of the word should be successively pressed to enter a number pattern, which is then terminated by the “0” key 110. During typing, the display 200 will just show the numbers of the typed keys. Should any mistake be made, the “Clear” key 202 can be used as backspace to cancel the previous keying.

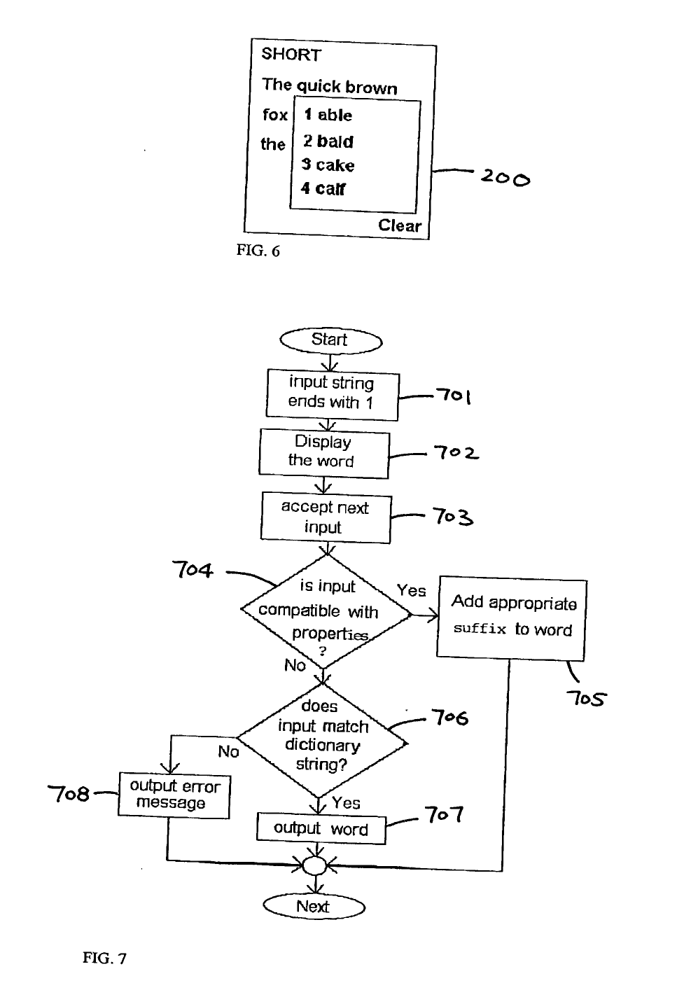

Once the “0” key 110 is tapped, the program of the input system/method searches through its dictionary to find a match for all possible words having the same number pattern just keyed in. If only one match is found, the word will be entered onto the display 200. In the case that more than one match are found, for example when the number pattern “22530” is keyed in that matches four words “able”, “bald”, “cake” and “calf”, these choices will be displayed and numbered in alphabetical order for selection as shown in FIG. 6.

The associated number key can then be hit to enter the desired word. The number of choices which can be presented at one time will depend on the size of the display 200. If the number of choices exceeds the limit, the last line will show “ . . . n more”, where n is the number of choices that have not yet been shown and can be brought up by pressing the associated number key.

When an input string is terminated with the “0” key 110, the word displayed will be followed by a space. Also, for the first word entered, or the first word entered after a period “.”, the beginning letter of the word will be capitalized. Thus, the SHORT mode is particularly suitable for inputting grammatical text.

As best illustrated in FIG. 7, the SHORT mode offers an easier way to input a long word by keying in only the initial string or first few letters of the word and then ending with the “1” key 101 (Box 701). Terminating with the “1” key 101 will not produce a space, but instead the program of the input system/method will compare and match the number pattern just keyed in with the beginning of all the number patterns available in its dictionary. If only one match is found, the word will be displayed and entered (Box 702).

In practice, however, depending on the number of initial letters keyed in, there are often more than one match found, and given the different possible forms of a particular word, the choices can be too plentiful. For example, the possible words matching with an initial string of “277761” for “appro” are “approach”, “approaches”, “approached”, “approaching”, “approve”, “approves”, “approved”, “approving”, “approximate”, “approximates”, “approximated”, “approximating”, “approximately”, “approximation”, “appropriate”, “appropriates”, “appropriated”, “appropriating”, “appropriation” and “appropriately”.

It will be tedious for a user to go through a long list of words in their various forms before choosing the right one. With a view to saving on the number of key strokes, the number of matching words to display for choosing and the size of the dictionary memory, only the root words together with their suffix properties are stored. The input system/method will only display the matching words in their root form, and a user can then choose the desired root word and later add on a suitable suffix.

The dictionary allocates three fields for each root word stored in the memory. The first field holds a number string corresponding to the letters of the word for matching, the second field holds the word itself, and the last field is a properties field holding an alphabet string representing all possible suffixes for the word. The letters in the properties field are:

“r”—regular verbs, e.g. “walk”

“v”—verbs that can end with “s” and “ing”, e.g. “cut”

“u”—verbs that can end with “s” and “ed”, e.g. “die”

“m”—verbs that can end with “ment”, e.g. “govern”

“t”—verbs that can end with “tion”, e.g. “contribute”

“a”—adjectives and adverbs that can end with “er”, “est”, “ly” and “ness”, e.g. “calm”

“e”—adjectives and adverbs that can end with “er” and “est”, e.g. “often”

“l”—adjectives that can end with “ly”, e.g. “annual”

“s”—adjectives and adverbs that can end with “ness”, e.g. “aware”

“n”—nouns in plural form that can end with “s”

“i”—words which cannot have any suffixes appended

Thus, the word “appropriate” has a number string field of “27776774283” and a properties field of “rlst”. In general, the suffixes represented by an alphabet string are each represented by a single distinctive letter.

The number string field can be omitted if the memory space is limited, and instead can be generated during the search, though the system performance will inevitably be slowed down to some extent.

For appending a suffix, the root word must first be obtained using termination with the “1” key (Box 701). Terminating a word with the “0” key will automatically produce a following space, and the suffix function will remain inactive even if the user backspace with the “Clear” key. To add the various suffixes, the following numeric (alphabetic) suffix patterns followed by the key “0” should be used (Box 703):

| | |
|---|---|
| “3”(d) | past tense “d” or “ed” |
| “7”(s) | plural nouns or singular verb |
| | conjugation “s” or “es” |
| “464”(ing) or “4”(i) | continuous tense “ing” |
| “37”(er) | comparative form “er” |
| “378”(est) | superlative form “est” |
| “59”(ly) or “5”(l) | adjective to adverb “ly” |
| “6377”(ness) or “6”(n) | adjective to noun “ness” |
| “6368”(ment) or “6”(m) | verb to noun “ment” |
| “8466”(tion) or “8”(t) | verb to noun “tion” |

Each suffix is represented by one or more letters comprised thereby, and is arranged to be inputted by pressing the associated numeric (alphabetic) key or keys. In general, most of the suffixes are represented by only one letter, as shown above, in which case they are represented by their only or initial letter.

When a word is entered with termination using the “1” key (Box 701) and the next input string is terminated with the “0” key (Box 703), the input system will first check whether the input string is one of the suffix patterns listed above. If the string represents a predefined suffix that is also compatible with the properties field of the word (Box 704), the suffix will be appended to the word in the proper form (Box 705) and the complete word is inputted and displayed. For example, adding “s” to “calm” will produce “calms”, whereas adding “s” to “brush” will produce “brushes”.

If the input string does not represent any suffix, the input system will compare it with the number strings in the dictionary (Box 706) and then display the corresponding complete word upon finding a match (Box 707). This allows for compound words, such as “businessman” and “beachfront”, to be easily entered. Should the input string not match with any entry in the dictionary, the system will just produce the error message “No match” on the display 200 (Box 708).

If “0” or “1” key is pressed before any other number keys, the system will bring up the grids of punctuation marks and symbols on the display 200 as in the LONG mode.

Besides normal text, the input system/method is also capable of inputting passwords. As passwords are usually formed by a sequence of unrelated letters, numbers and/or symbols, it is not possible to type a password using any text-predictive scheme. Passwords can, however, be easily entered using the LONG mode, which is for inputting alphanumeric texts with symbols and punctuation marks as described above. The only difference is that a series of asterisks “*” will be displayed once a string is inputted instead of the entered characters.

It is envisaged that the dictionary to be searched for matches needs not reside in the keypad device itself, but in a remote location such as a server with which the keypad device can communicate for example via the Internet.

In a global marketplace of dozens of stock exchanges, each listing hundreds of stocks, it is impossible for a trader to memorize the code for each stock. Using the subject input system/method, the user can simply type in a shortened version of the name of a desired stock and then let the system find a match through the dictionary of his broker to whom the user's keypad device is connected. Suppose that the user wants to trade Creative Technologies Warrants 2005, he can connect to his broker's server and, when prompted, enter “21819121”. Even if more than one match is found, they can easily be displayed for selection by the user.

If a new word has been entered that is not present in the dictionary, the system will prompt the user to enter it into the dictionary. New words entered into the dictionary will not have the properties field, and can have a number pattern field that is not derived from the word itself. For example, the name “Jonathan” may be assigned the number pattern “54” (capital J in LONG mode) so that keying in the number “540” will enter the name immediately. The user can also create signatures, such as “John Smith, Network Manager, e-mail: jsmith@xyz.com”, and use the number pattern “633744”, corresponding to “offsig” short for “official signature”, to represent it.

The subject invention does not make use of any text prediction. Instead, the input system attempts to match the number pattern keyed in with entries in its internal memory to obtain a desired word, or allows a user to choose whatever characters (whether letters, numbers, punctuation marks or other symbols) he/she wishes to input, both in a simple direct manner.

The invention has been given by way of example only, and various other modifications of and/or alterations to the described embodiment may be made by persons skilled in the art without departing from the scope of the invention as specified in the appended claims.

1. An alphanumeric data input system comprising a 3×4 alphanumeric keypad of keys, a display, and a program controlling the operation of these components, the keys representing digits from “0” to “9” and “*” and “#” signs respectively and the keys for digits from “2” to “9” also representing the letters of alphabet sequentially in respective groups of three to four letters, wherein at least one of the keys upon pressing will cause the display to display the letters of the associated group in both lowercase and uppercase and the associated number together in the form of a grid of locations corresponding in position to the keys of the keypad, and subsequent pressing of one of the keys corresponding to the location at which a desired character is displayed will result in input of that character, thereby allowing any sequence of characters to be inputted.

2. The alphanumeric data input system as claimed in claim 1, wherein a predetermined location of the grid is arranged to display the number associated with the key first pressed.

3. The alphanumeric data input system as claimed in claim 2, wherein the predetermined location of the grid is the last location of the third row.

4. The alphanumeric data input system as claimed in claim 1, wherein the keys for “0” and “1” also represent punctuation marks and symbols, either one of which upon pressing will cause the display to display a set of predetermined punctuation marks or symbols in the form of a grid of locations corresponding in position to the keys of the keypad, and subsequent pressing of one of the keys corresponding to the location at which a desired punctuation mark or symbol is displayed will result in input of that mark or symbol.

5. The alphanumeric data input system as claimed in claim 4, wherein one of the displayed locations represents additional punctuation marks or symbols, and pressing of the key corresponding to that location will cause the display to display a set of the additional punctuation marks or symbols in the form of a grid of locations corresponding in position to the keys of the keypad for subsequent input of a desired punctuation mark or symbol in the aforesaid manner.

6. An alphanumeric data input method comprising the steps of providing a 3×4 alphanumeric keypad of keys and a display, running a program to control the operation of these components, the keys representing digits from “0” to “9” and “*” and “#” signs respectively and the keys for digits from “2” to “9” also representing the letters of alphabet sequentially in respective groups of three to four letters, pressing at least one of the keys to cause the display to display the letters of the associated group in both lowercase and uppercase and the associated number together in the form of a grid of locations corresponding in position to the keys of the keypad, and subsequently pressing one of the keys corresponding to the location at which a desired character is displayed to input that character, thereby allowing any sequence of characters to be inputted.

7. The alphanumeric data input method as claimed in claim 6, including displaying the number associated with the key first pressed at a predetermined location of the grid.

8. The alphanumeric data input method as claimed in claim 7, wherein the predetermined location of the grid is the last location of the third row.

9. The alphanumeric data input method as claimed in claim 6, wherein the keys for “0” and “1” also represent punctuation marks and symbols, including pressing the key for “0” or “1” to cause the display to display a set of predetermined punctuation marks or symbols in the form of a grid of locations corresponding in position to the keys of the keypad, and subsequently pressing one of the keys corresponding to the location at which a desired punctuation mark or symbol is displayed to input that mark or symbol.

10. The alphanumeric data input method as claimed in claim 9, wherein one of the displayed locations represents additional punctuation marks or symbols, further including pressing the key corresponding to that location to cause the display to display a set of the additional punctuation marks or symbols in the form of a grid of locations corresponding in position to the keys of the keypad for subsequent input of a desired punctuation mark or symbol in the aforesaid manner.

11. An alphanumeric data input system comprising a 3×4 alphanumeric keypad of keys, a display, a memory storing a database of words and suffixes, and a program controlling the operation of these components, the keys representing digits from “0” to “9” and “*” and “#” signs respectively and the keys for digits from “2” to “9” also representing the letters of alphabet sequentially in respective groups of three to four letters, wherein pressing of the keys representing the initial string of a word will enable matching through the database for a word sharing the same initial string and then displaying of the word in its root form on the display, and subsequent pressing of one or more of the keys representing a respective suffix available from the database will result in addition of the suffix to the root word and thus input of the complete word.

12. The alphanumeric data input system as claimed in claim 11, wherein a first predetermined key is arranged upon pressing to terminate the input of the initial string, and a second predetermined key is arranged upon pressing to terminate the input of the suffix.

13. The alphanumeric data input system as claimed in claim 12, wherein the first and second predetermined keys are the keys for “1” and “0” respectively.

14. The alphanumeric data input system as claimed in claim 11, wherein each suffix is represented by one or more letters comprised thereby, and is arranged to be inputted by pressing the associated key or keys.

15. The alphanumeric data input system as claimed in claim 14, wherein the suffixes that are represented by one letter are represented by their only or initial letter.

16. The alphanumeric data input system as claimed in claim 11, wherein each root word is stored in the database in three fields, with the first field for a number string corresponding to its letters for matching, the second field for the word itself, and the last field for an alphabet string representing all possible suffixes for the word.

17. The alphanumeric data input system as claimed in claim 16, wherein the suffixes represented by the alphabet string are each represented by a single distinctive letter.

18. An alphanumeric data input method comprising the steps of providing a 3×4 alphanumeric keypad of keys, a display and a memory storing a database of words and suffixes, running a program to control the operation of these components, the keys representing digits from “0” to “9” and “*” and “#” signs respectively and the keys for digits from “2” to “9” also representing the letters of alphabet sequentially in respective groups of three to four letters, pressing the keys representing the initial string of a word for matching through the database for a word sharing the same initial string and then displaying the word in its root form on the display, and subsequently pressing one or more of the keys representing a respective suffix available from the database for addition of the suffix to the root word and thus input of the complete word.

19. The alphanumeric data input method as claimed in claim 18, including pressing a first predetermined key to terminate the input of the initial string, and pressing a second predetermined key to terminate the input of the suffix.

20. The alphanumeric data input method as claimed in claim 19, wherein the first and second predetermined keys are the keys for “1” and “0” respectively.

21. The alphanumeric data input method as claimed in claim 18, wherein each suffix is represented by one or more letters comprised thereby, including pressing the associated key or keys to input the suffix.

22. The alphanumeric data input method as claimed in claim 21, wherein the suffixes that are represented by one letter are represented by their only or initial letter.

23. The alphanumeric data input method as claimed in claim 18, including storing each root word in the database in three fields, with the first field for a number string corresponding to its letters for matching, the second field for the word itself, and the last field for an alphabet string representing all possible suffixes for the word.

24. The alphanumeric data input system as claimed in claim 23, wherein the suffixes represented by the alphabet string are each represented by a single distinctive letter.
